(19) United States
(12) Patent Application Publication
(10) Pub. No.: US 2023/0134227 A1
(43) Pub. Date: May 4, 2023

(54) DIGITAL PLATFORM FOR EVALUATING BETTING ODDS

(71) Applicant: OddsJam, Inc., Falls Church, VA (US)

(72) Inventors: Ankit Goyal, Falls Church, VA (US); Alexander David Monahan, Falls Church, VA (US)

(73) Assignee: OddsJam, Inc., Falls Church, VA (US)

(21) Appl. No.: 17/979,810

(22) Filed: Nov. 3, 2022

Related U.S. Application Data
(60) Provisional application No. 63/275,469, filed on Nov. 4, 2021.

(51) Int. Cl. G07F 17/32; G06Q 50/34

(52) U.S. Cl. CPC G07F 17/323; G07F 17/3288; G06Q 50/34

(57) ABSTRACT

Disclosed techniques enable evaluating betting odds using a digital platform. Two or more digital betting platforms are accessed. The digital betting platforms each provide one or more betting odds opportunities for an online user. The digital betting platforms comprise digital sportsbooks. The betting odds opportunities include an outcome of a head-to-head sporting contest. The betting odds opportunities from the digital betting platforms are parsed to enable identification of at least one common betting odds opportunity. Vigorish included by the digital betting platforms is removed from the betting odds opportunities. An odds discrepancy is identified between the two or more digital betting platforms for the common betting odds opportunity. A request is received from the online user for the common betting odds opportunity. An automated response is provided to the online user. The response contains information on the common betting odds opportunity.

### RELATED APPLICATIONS

This application claims the benefit of U.S. provisional patent application “Digital Platform For Evaluating Betting Odds” Ser. No. 63/275,469, filed Nov. 4, 2021.

The foregoing application is hereby incorporated by reference in its entirety.

### FIELD OF ART

This application relates generally to evaluating betting odds and more particularly to a digital platform for evaluating betting odds.

### BACKGROUND

Gambling is based on wagering an item of value. The wager can be placed on the outcome of an event such a game, a race, or even a bird landing on a feeder within the next minute. The wager can include the mundane such as who takes out the trash or buys lunch, to the monumental. On many occasions, the wager involves an amount of money. If a bet is lost, then the wagered money is also lost. If the bet is won, then an amount greater than the bet can be received by the person placing the winning wager. Entire fortunes have been won or lost based on the outcome of even a single wager. The prospect of winning a bet and receiving a big payout is highly attractive. As a result, roughly a quarter of world's population gambles at least once a year. Wagers can be placed in betting venues such as casinos and sportsbooks, and off-site betting facilities, among others. Gambling has found a worldwide market through online gambling. This latter approach enables those interested in placing a wager to do so from their computer, smartphone, smartwatch, or another web-enabled device. Among the most popular events on which individuals place wagers include sporting events. Fantasy sports betting has also become enormously popular. To compete in a fantasy sports league, a participant creates a fantasy team that includes real players from real teams. The individual who created the fantasy team wins points each week depending on how the players play each week. Still another popular wagering type is based on e-sports. In these latter events, individuals or teams of players compete against other individuals or teams while playing video games. This e-sports betting market is said to be growing more than 20 percent per year.

The actions of choosing an event on which to place the bet, and the thrill wining, keep avid gamblers playing. The bet can include money, property, cryptocurrency, or other representations of value agreed upon by the parties participating in the bet. Bets are commonly staked in games of chance. Card games, dice games, and spins of roulette wheels, and by far the most popular, the lottery, all compel people to pit their skills or take their chances against the odds. Bets can also be placed on common events, uncommon events, and silly contests. The results of elections, the date of a birth of a child, the date of death of a celebrity, or the name of a next religious leader all attract gamblers who are convinced that their predictions are the correct and winning ones. Cultural, regional, and national events also attract gamblers. Spouse-carrying races, downhill cheese rolling, ferret bingo, bog snorkeling, or proof of existence of life beyond earth all offer gamblers the opportunity to place bets in the hopes of large payouts while having a bit of fun. Whatever the event that takes place, or their reasons for doing so, there are many people who love to place a bet.

### SUMMARY

Techniques describing a digital platform for evaluating betting odds are described. Digital betting platforms are accessible via the Internet to those who are interested in gambling. The betting platforms vary widely, but typically provide betting information about events and odds. The betting platforms further offer the ability to easily accomplish placing bets through a web browser or betting app using a computer or personal electronic device. The enterprises that host the digital betting platforms are located around the world, and offer gamblers opportunities to place wagers on contests, events, races, elections, and so on. Because the digital betting platforms are located at sites and in countries around the world, a gambler can readily choose a site that offers betting opportunities that are associated with sporting contests, events, or other activities on which the gambler wishes to place wagers. When choosing a digital betting platform with which to place a bet, the gambler must be aware of many, and often subtle, inconsistences among the betting platforms. The inconsistencies include disparate odds representations; unequal vigorish (fee) charges; creative abbreviations of names, times, dates, locations, and nomenclature; and so on. As a result, direct comparisons of contest offerings, competitors and team names, and associated odds are nontrivial.

The betting platforms include digital sportsbooks, where the digital sportsbooks provide at least game-level outcome odds. The outcome odds can be presented on the sites using a variety of codes and abbreviations. A digital platform for evaluating betting odds can be used to parse the betting opportunities offered by multiple digital betting platforms. The digital platform accesses two or more digital betting platforms that provide betting odds opportunities. The digital platform can “normalize” disparate odds opportunities representations by parsing the odds opportunities. The parsing can enable matching of odds opportunities between digital betting platforms by matching disparate representations of a contestant name or team name, contest date, contest venue, or contest odds representation. The digital platform can remove a vigorish charged by the digital betting platform to gain a clearer view of the odds of various bets and amounts of possible winnings. The digital platform can also identify a statistically mispriced bet, where the mispriced bet itself becomes a betting opportunity. The digital platform can access two or more digital betting platforms at least twice per minute. The accessing the digital betting platforms at least twice per minute enables dynamically identifying one or more further odds discrepancies. The digital platform can notify interested online users of both betting opportunities and dynamically changing opportunities.

A computer-implemented method for evaluating betting odds is disclosed comprising: accessing two or more digital betting platforms, wherein the two or more digital betting platforms each provide one or more betting odds opportunities for an online user; parsing the one or more betting odds opportunities from the two or more digital betting platforms to enable identification of at least one common betting odds opportunity; identifying an odds discrepancy between the two or more digital betting platforms for the common betting odds opportunity; receiving a request from the online user for the common betting odds opportunity; and providing an automated response to the online user, wherein the response contains information on the common betting odds opportunity. The digital betting platforms comprise digital sportsbooks, where the digital sportsbooks provide at least game-level outcome odds. The one or more betting odds opportunities include an outcome of a head-to-head sporting contest. Vigorish included by the two or more digital betting platforms is removed from the one or more betting odds opportunities. The removing vigorish is used to adjust the odds discrepancy that was identified. The removing the vigorish further enables identification of a potential positive expected value for the one or more betting odds opportunities. The potential positive expected value enables the online user to bet on a long-term basis.

The at least one common betting odds opportunity enables the online user to place a bet on each contestant of the head-to-head sporting contest. The accessing two or more digital betting platforms occurs at least twice per minute. The accessing two or more digital betting platforms occurring at least twice per minute enables dynamically identifying one or more further odds discrepancies. The dynamically identifying one or more further odds discrepancies enables dynamic user notification. The parsing includes matching disparate representations of a contestant name, contest date, contest venue, or contest odds. The parsing includes conversion of disparate contest odds representations.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a digital platform for evaluating betting odds.

FIG. 2 is a flow diagram for betting.

FIG. 3 is a system block diagram for evaluating betting odds.

FIG. 4 illustrates a digital platform user interface.

FIG. 5 is a table showing sports betting opportunities.

FIG. 6 is a system diagram for digitally evaluating betting odds.

### DETAILED DESCRIPTION

Betting, and especially online betting, has become enormously popular. Users interested in placing bets are confronted with a dizzying array of online betting sites. The sites, which are located around the world, offer myriad betting opportunities on an enormous variety of events. The events include sporting contests, election results, the date of arrival of a new family member, and the longevity of a celebrity marriage, among many others. The sporting contests can include horse and automobile races, beach volleyball tournaments, tennis matches, professional sports games, and turtle races, to name a very few. The bets can be placed on events and situations that occur during a sporting contest, on the outcome or outcomes of a sporting contest, etc. The online betting sites use terms that to newcomers can seem bewildering. While some terms such as winner, loser, or total points can appear obvious, other terms are less clear. Partial game points, game spread, game proposition bets or “props”, and individual contest props can be abstruse to the neophyte gambler. To assist an online gambler who is interested in placing a bet, the online betting sites provide odds for each betting opportunity. The user must understand different odds formats while she or he is searching for a betting opportunity.

In addition to being able to place bets on various events, an individual can choose to participate in another type of betting referred to as “futures betting”. Futures bets can be placed on events, contests, and so on, that can take place at a future date. Unlike a future event such as a title match between two championship contenders, the futures bets can be made without even knowing who the participants will be. In a usage example, an individual can place bets on the winner of a championship, the first-round draft pick, the most valuable player (MVP), and so on. The user places her or his bets based on the odds, then waits for the outcome of the event to become known. The bets can be placed even before a sports season has started, the contenders in the event are known, etc. For the case of an event associated with a sports season such as football (soccer), American football, or a Union Cycliste Internationale (UCI) sanctioned stage race, betting odds can be opened prior to the opening of the season. As the season progresses, the odds can be changed, adjusted, and so on based on results of the season, health of or injury to key participants, trades or retirements of personnel, a total value of wagers received, and so on. Irrespective of how the odds may be adjusted, whether up, down, or unchanged, the odds that were available at the time the user (e.g., the bettor) places her or his bet remain for that bettor for the remainder of the futures bet. The sportsbooks can continue to adjust their odds as the season, stages of a race, and so on, progress.

An individual can base her or his decisions to place futures bets and choose the timing of placing those bets on the odds offered by one or more sportsbooks. The odds for futures bets can be presented in a variety of formats such as a table, a list, and so on. The odds can be ranked, where the individual, the team, etc. with the best chance of a favorable outcome (e.g., winning) can be listed first, while the individual, team, etc. with the least chance of a favorable outcome can be listed last. The rankings can also show expected payouts for a given individual or team if that individual or team wins. In a usage example, a team that is deemed likely to win will have a lower payout than the payout for a team that has a lower chance of winning. The rankings within the list can change during the season as outcomes of intervening events such as matches played become known. The ranking can further change due to injuries, personnel changes, etc. An implied probability of success can be calculated for each futures bet based on the odds associated with a given futures bet. If the implied probability of success is high, then risk associated with a bet can be relatively low. Commensurate with the lower level of risk, the payout associated with the bet can also be relatively low. Conversely, if the implied probability of success is low, then the risk associated with a bet is relatively high and the payout for a successful outcome for that bet can be relatively high. Thus, bets associated with high implied probability yield low payouts, while bets associated with low implied probability yield high payouts.

Techniques for evaluating betting odds using a digital platform are disclosed. Two or more digital betting platforms are accessed. The two or more digital betting platforms each provide one or more betting odds opportunities for an online user. The online user can access a digital platform using a web browser, a web form, a web app, an app loaded on a personal electronic device, and so on. The betting odds opportunities can include sporting and other events. The one or more betting odds opportunities are parsed from the two or more digital betting platforms to enable identification of at least one common betting odds opportunity. The parsing can recognize common betting odds opportunities by decoding abbreviations, expanding participant initials, substituting names for nicknames, converting calendar formats, etc. An odds discrepancy is identified between the two or more digital betting platforms for the common betting odds opportunity. The odds discrepancies can be attributable to modeling differences, differences in bookmaker opinion, delayed updates to odds, and the like. A request is received from the online user for the common betting odds opportunity. The request can be received via a webpage, web app, app, app on a device, etc. An automated response is provided to the online user. The response contains information on the common betting odds opportunity. The response can include a text message, an email message, an alert, an update on a webpage, and so on.

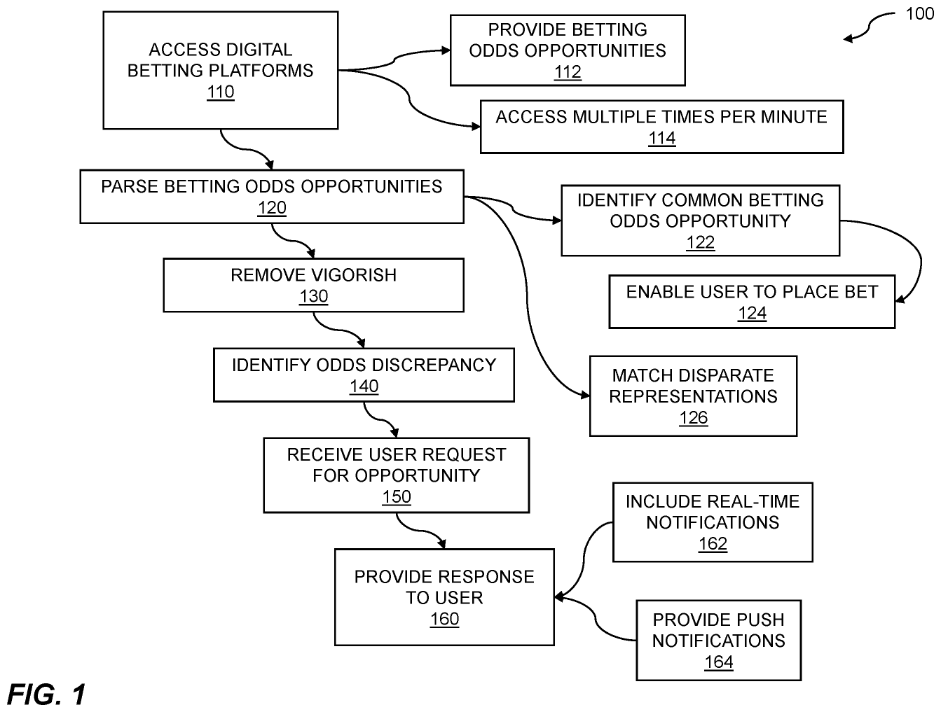

FIG. 1 is a flow diagram for a digital platform for evaluating betting odds. Betting odds are determined by sportsbooks and offered through digital betting platforms to potential online bettors. Betting odds differences can occur between sportsbooks. By accessing two or more digital betting platforms, betting odds opportunities can be provided. The betting odds opportunities are parsed to enable identification of at least one common betting odds opportunity, such as sporting event listed by the two or more sportsbooks. An online user interested in placing a bet can request the identified, common betting odds opportunity. An online response can be generated by a digital platform for evaluating betting odds. The flow 100 includes accessing 110 two or more digital betting platforms, wherein the two or more digital betting platforms can comprise digital sportsbooks. The digital sportsbooks enable a user such as an online user to place bets on a variety of events such as sporting events. In embodiments, the digital sportsbooks can provide at least game-level outcome odds. In the flow 100, each of the two or more digital betting platforms provides one or more betting odds opportunities 112 for an online user. A betting opportunity can include placing a bet on team, an individual contestant, multiple contestants, and so on. A betting odds opportunity can include betting on an outcome of a sporting contest. In a usage example, a betting opportunity can include betting that a first team will defeat a second team in a sporting event. The betting can further include a points spread. In embodiments, the outcome of the sporting contest can include winner, loser, total points, partial game points, game spread, game proposition bets or “props”, and individual contest props. The flow 100 can include accessing the two or more digital betting platforms multiple times per minute 114. In embodiments, the accessing two or more digital betting platforms can occur at least twice per minute. The frequency of accessing can be changed based on an event such as a rain delay, a participant injury, and the like.

The flow 100 includes parsing 120 the one or more betting odds opportunities from the two or more digital betting platforms. An odds opportunity can include an opportunity to bet on an event such as a sporting event. A sports betting platform can provide betting odds opportunities in a variety of data formats, graphical representations, and so on. In the flow 100, the parsing enables identification 122 of at least one common betting odds opportunity. A common odds opportunity can include a sporting event available on two or more digital betting platforms. A common odds opportunity can include a game such as a Boston Red Sox versus New York Yankees baseball game. In embodiments, the common betting odds opportunity can include a statistically mispriced bet. A statistically mispriced bet can occur due to a modeling error, a difference of opinion, a failure to act in a timely manner to an update such as a play injury, and so on. In embodiments, the statistically mispriced bet can enable a positive expected value betting outcome on one participant of the head-to-head sporting contest. In the flow 100, the at least one common betting odds opportunity enables the online user to place a bet 124. The bet can be placed through a digital betting platform. Bets can be placed on various types of sporting events or contests. In embodiments, the at least one common betting odds opportunity can enable a user such as an online user to place a bet on the outcome of a head-to-head sporting contest. The sporting contest can be a contest between two or more individuals, two or more teams, and so on. In embodiments, the one or more betting odds opportunities can include an outcome of a three or more participant sporting contest. Bets can be placed on one or more individuals. In embodiments, the at least one common betting odds opportunity enables the online user to place a bet on at least one participant of the three or more participant sporting contest.

A variety of types of bets can be placed based on the identified common betting odds opportunity. In embodiments, the bet can be placed on each contestant of the head-to-head sporting contest. A bet on each contestant can comprise an arbitrage bet. An arbitrage bet can be based on different odds being offered by different sportsbooks. In embodiments, the bet on each contestant can guarantee a positive expected value betting outcome. The positive expected value can be based on an amount, a percentage, and so on. A bet based on a positive expected value can enable a positive return at lower risk to the bettor. In other embodiments, the bet on each contestant can include a low-hold bet. A low-hold bet can be based on a lower percentage collected on bets by a sportsbook maker. In embodiments, the bet on each contestant can include a middle bet. A middle bet can include placing bets on both outcomes of an event such as a sporting event. The bets are placed with different sportsbooks. A middle bet betting opportunity can occur when odds associated with an event are different on two or more different sportsbooks. In the flow 100, the parsing can include matching disparate representations 126 of a contestant name, contest date, contest venue, or contest odds representation. In a usage example, disparate representations of a contestant name can include name representations such as first name-last name, last name-first name, first initial-last name, last name-first initial, and so on. The disparate representations can include nicknames. In embodiments, the parsing can include conversion of disparate contest odds representations. Odds representations can include decimal, fractional, percentage, American, and the like.

The flow 100 further includes removing vigorish 130 included by the two or more digital betting platforms from the one or more betting odds opportunities. The vigorish can include a fee, a percentage, etc., that can be deducted from the winnings of a bettor. In embodiments, the removing vigorish can be used to adjust the odds discrepancy that was identified. The vigorish, or “vig”, can vary between sportsbooks. By removing the vigorish, any odds discrepancy between digital betting platforms can be compared. In embodiments, the removing the vigorish can enable identification of a potential positive expected value for the one or more betting odds opportunities. A positive expected value can enable a positive betting outcome for a bettor over time. In embodiments, the potential positive expected value can enable the online user to bet profitably on a long-term basis.

In the flow 100, the accessing two or more digital betting platforms occurs at least twice per minute which enables dynamically identifying 140 one or more further odds discrepancies. The digital betting platforms described previously can be accessed periodically. The periodic access can be used to detect changes in odds, where changes in odds can occur due to delays of a contest resulting from weather or other interruptions, player injury, and so on. An odds discrepancy can occur between digital betting platforms based on different models used to calculate odds, differences of opinion about the odds associated with a participant, and so on. Returning to the situation in which a participant in a sporting event is injured, one digital betting platform can update odds, while another digital betting platform has yet to do so. The resulting odds discrepancy can be identified as a betting opportunity. In embodiments, the dynamically identifying one or more further odds discrepancies can enable dynamic user notification (discussed below).

The flow 100 includes receiving a request 150 from the online user for the common betting odds opportunity. The request from the online user can be received from a webpage, a web-based form, a web-based app, an app installed on a personal electronic device associated with the online user, and so on. The user can send the request using a free service, a subscription service, a pay-as-you-go service, and the like. The flow 100 includes providing an automated response to the online user 160, wherein the response contains information on the common betting odds opportunity. The response can include a recommendation, a table or chart illustrating opportunities, etc. The flow 100 includes providing real-time notifications 162. A real-time notification can include a push notification, a text message, an email message, and the like. The notifications can include offers to receive betting opportunity recommendations, updates to previously viewed betting opportunities, and the like. The flow 100 can include providing push notifications 164 to a user. The push notifications can include text messages, email messages, and so on. The push notifications can be based on dynamically identified odds discrepancies. The push notifications can include sporting contest scores, news updates such as player penalties or injuries, etc.

The flow 100 can include a computer-implemented method for evaluating betting odds comprising: accessing two or more digital betting platforms, wherein the two or more digital betting platforms each provide one or more betting odds opportunities for an online user; parsing the one or more betting odds opportunities from the two or more digital betting platforms to enable identification of at least one common betting odds opportunity; identifying an odds discrepancy between the two or more digital betting platforms for the common betting odds opportunity; receiving a request from the online user for the common betting odds opportunity; and providing an automated response to the online user, wherein the response contains information on the common betting odds opportunity. The accessing, the parsing, the identifying, the receiving, and the providing can each be performed by one or more processors and/or one or more computing devices. The accessing, the parsing, the identifying, the receiving, and the providing can each be performed by the same one or more processors or different one or more processors. In embodiments, a computer program product is embodied in a non-transitory computer readable medium for evaluating betting odds, the computer program product comprising code which causes one or more processors to perform operations of: accessing two or more digital betting platforms, wherein the two or more digital betting platforms each provide one or more betting odds opportunities for an online user; parsing the one or more betting odds opportunities from the two or more digital betting platforms to enable identification of at least one common betting odds opportunity; identifying an odds discrepancy between the two or more digital betting platforms for the common betting odds opportunity; receiving a request from the online user for the common betting odds opportunity; and providing an automated response to the online user, wherein the response contains information on the common betting odds opportunity.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

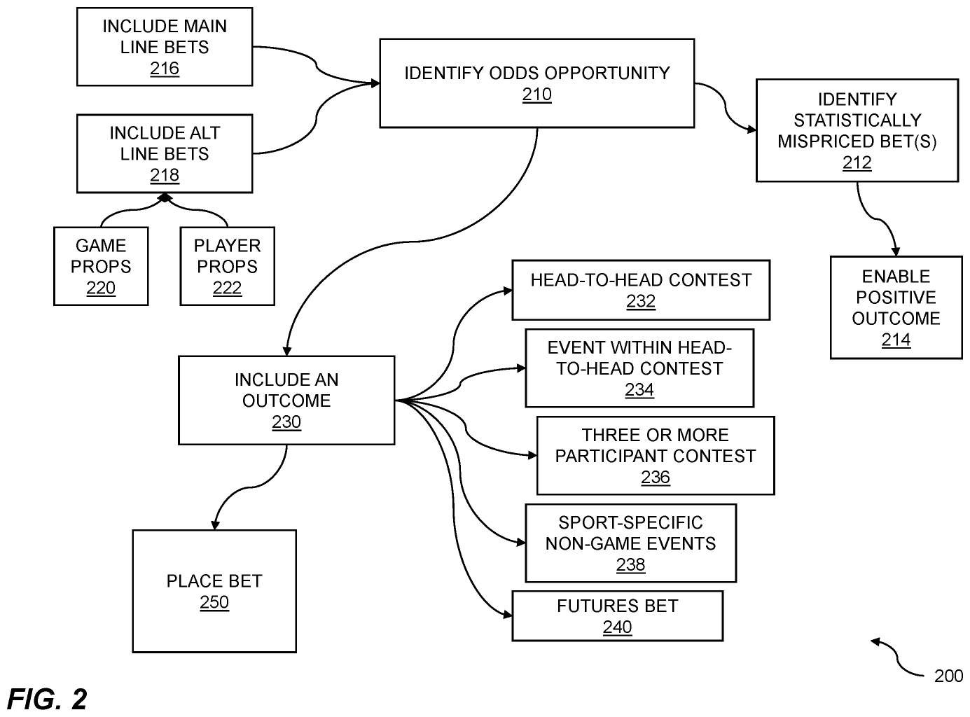

FIG. 2 is a flow diagram for betting. The betting can be accomplished by accessing a digital betting platform. The bettor can improve her or his chances of placing a successful bet by requesting information associated with a common betting odds opportunity. The common betting odds opportunity can be identified by evaluating betting odds. The evaluating betting odds can be accomplished using a digital platform. Two or more digital betting platforms are accessed, wherein the two or more digital betting platforms each provide one or more betting odds opportunities for an online user. The one or more betting odds opportunities from the two or more digital betting platforms are parsed to enable identification of at least one common betting odds opportunity. An odds discrepancy is identified between the two or more digital betting platforms for the common betting odds opportunity. A request is received from the online user for the common betting odds opportunity. An automated response is provided to the online user, wherein the response contains information on the common betting odds opportunity. In the flow 200, the statistically mispriced bet can enable a positive outcome 214. In embodiments, the positive outcome can include a positive expected value betting outcome.

The flow 200 includes identifying an odds opportunity 210. The odds opportunity can include a common odds opportunity. An odds opportunity can occur when there is a difference in odds offered by two or more sportsbooks. The difference in odds can result from modeling differences, a modeling error, differing opinions, and so on. The flow 200 includes identifying a statistically mispriced bet 212. A statistically mispriced bet can result from a modeling error. In a usage example, a key participant in a sporting event can become injured prior to or during the event. Since the injured key player cannot participate further in the event, the outcome of the event could change, thus changing odds associated with the event. If the sportsbook is slow to update the odds, then the odds can remain mispriced until updated. In the flow 200, the identifying can include one or more main line bets 216. A main line bet can include a simple wager placed a team, participant, and so on, whom the bettor believes will win a sporting event. A main line bet can include betting on a winner or a loser, betting of a points total for an event, betting on a margin (e.g., a points spread), etc. The bet may or may not be made with a points spread, conditions of the win, etc. In the flow 200, the identifying can include one or more alternate line bets 218. An alternate line bet can include a bet with a narrower points spread, a bet at different time intervals within the event, such as a quarter, half time, period, and the like. In the flow 200, an alternate line includes game propositions 220 or “props”. A game prop relates to more granular results of a game, such as how many total points will be scored by the end of the first quarter or half, who will be leading at halftime, etc. In the flow 200, an alternate line includes player propositions 222. A player prop relates to player outcomes of the game, such as how many touchdowns a quarterback will score, how many points a specific basketball player will score, and so on.

In the flow 200, the one or more betting odds opportunities include an outcome 230. The outcome can include the outcome of a sporting event. The outcome can include a score, a win or a loss, and so on. In embodiments, the outcome of the sporting contest can include winner, loser, total points, partial game points, game spread, game props, individual contest props, and so on. The outcome can be associated with various types of sports events. In the flow 200, the outcome can be based on a head-to-head contest 232. A head-to-head contest is a contest in which individuals or teams compete directly with each other. In the flow 200, the outcome can be based on an event within a head-to-head contest 234. The event within the head-to-head contest can include completing a play, blocking a scoring attempt by an opponent, etc. In the flow 200, the outcome can be based on a three or more participant contest 236. In embodiments, the outcome can be based on one or more actions of one or more of the participants of the contest. In the flow 200, the outcome can be based on an outcome of the event of the sporting contest including sport-specific, non-game-outcome-related events 238. Sport-specific, non-game-outcome-related events can include weather conditions, home or away play, and so on. In the flow 200, the outcome can be based on the outcome of a futures bet 240. The futures bet can be based on the outcome of an event expected to occur in the future. The event can include a sporting event, a global competition, an election result, and so on. The futures bet can include a bet within the positive expected value (EV) bet. The futures bet can also include a time limit, a certain date, and so on. The futures bet can be based on one or more of annual contests and events such as the Superbowl™, the World Series™, the NBA™ championship, the number one draft pick, and the like. In a usage example, an individual wishes to place one or more bets on an upcoming Superbowl™ contest. The individual can place bets on which two teams will be playing, who will win the coin toss, who will win game, a points spread, and so on. The individual could further bet on one or more events within the game, sport-specific non-game events, etc.

The flow 200 includes placing bets 250. Discussed above and throughout, bets of various types can be placed using one or more digital betting platforms. The bets can be placed based on betting odds opportunities, where the betting odds opportunities can be identified by a digital platform that evaluates betting odds. In embodiments, the at least one common betting odds opportunity can enable an online user to place a bet on the outcome of a head-to-head sporting contest. The outcome can include winner, loser, etc. In other embodiments, the at least one common betting odds opportunity can enable the online user to place a bet on at least one participant of the three or more participant sporting contest. Bets can be placed on other numbers of participants. In embodiments, the at least one common betting odds opportunity can enable the online user to place a bet on each contestant of the head-to-head sporting contest.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

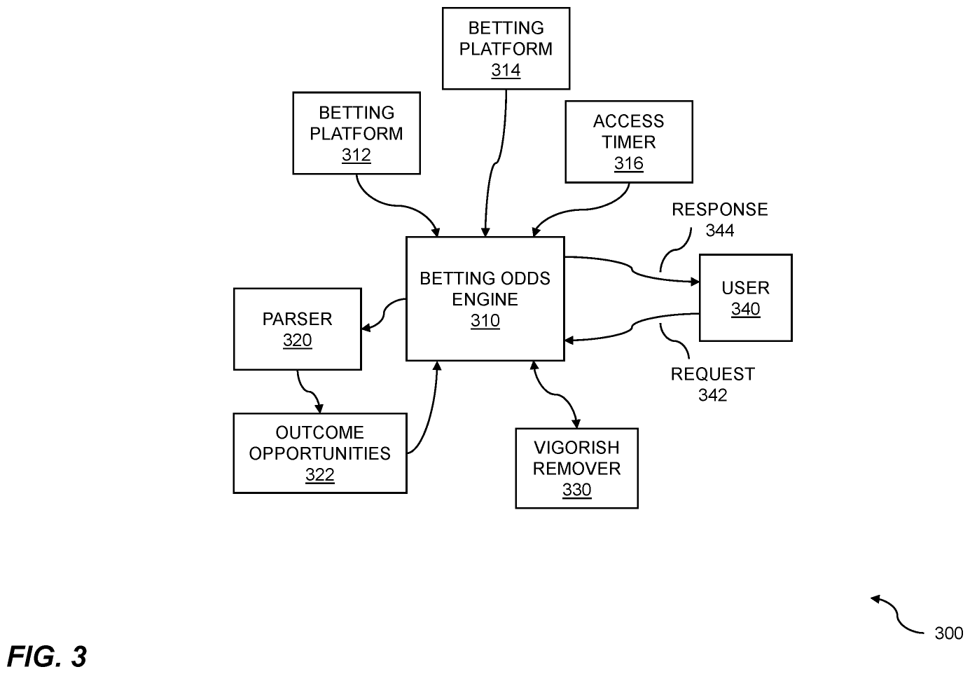

FIG. 3 is a system block diagram for evaluating betting odds. Described above and throughout, a digital platform can be used to access two or more digital betting platforms. The two or more digital betting platforms each provide betting odds opportunities for an online user. The betting odds opportunities can be associated with sporting events, competitions, bouts, and so on. The digital platform can identify odds discrepancies between the digital betting platforms. The odds discrepancies can be based on differences in opinions between sportsbooks, errors, and so on. Upon request from an individual, an automated response containing information on betting opportunities can be provided. The digital platform for evaluating betting odds is supported by the system described herein. Two or more digital betting platforms are accessed, wherein the two or more digital betting platforms each provide one or more betting odds opportunities for an online user. The one or more betting odds opportunities from the two or more digital betting platforms are parsed to enable identification of at least one common betting odds opportunity. An odds discrepancy is identified between the two or more digital betting platforms for the common betting odds opportunity. A request is received from the online user for the common betting odds opportunity. An automated response is provided to the online user, wherein the response contains information on the common betting odds opportunity.

A system block diagram for evaluating betting odds 300 is shown. The system block diagram 300 can include a betting odds engine 310. The betting odds engine can act as a controller or orchestrator for online digital betting, can provide data to and receive data from various components associated with digital betting, can communicate with an online user such as a bettor, and so on. The betting odds engine can access two or more digital betting platforms such as a first digital betting platform 312, a second digital betting platform 314, and so on. The first digital betting platform and the second digital betting platform can be located anywhere in the world where the Internet is accessible. While two digital betting platforms are shown, other numbers of digital betting platforms can be accessed. The two digital betting platforms can allow a variety of betting odds opportunities, where the betting odds opportunities can represent substantially similar representations or substantially different representations. The betting odds engine can be coupled to an access timer 316. Since betting odds associated with a sporting event can change over time, where the change can occur frequently and within short periods of time, any changes associated with the sporting event, such as changes in score, injury of a participant, weather delays, and so on, need to be detected and acted upon quickly. The access timer can be used to access the two or more betting platforms as needed, with a periodicity, intermittently, and the like. In embodiments, the accessing two or more digital betting platforms can occur at least twice per minute. The accessing can occur on the minute and the half-minute, or at other times within a minute. Other access frequencies such as four times per minute, ten times per minute, etc., can also be used. The access frequencies can be requested by a user, determined by the betting odds engine, and the like. In other embodiments, the accessing two or more digital betting platforms can occur at least twice per minute which enables dynamically identifying one or more further odds discrepancies. The identifying one or more further odds discrepancies can result in changes in odds, offerings of additional betting opportunities, etc.

The system block diagram 300 can include a parser 320. The parser can be used to parse the one or more betting odds opportunities from the two or more digital betting platforms. The parsing can be used to detect data associated with substantially similar betting odds opportunities. The data associated with betting odds can be represented using different formats. The parsing can be used to enable identification of at least one common betting odds opportunity from the two or more digital betting platforms. The system block diagram can include a component for outcome opportunities 322. The outcome opportunities, which can be based on betting opportunities, can be associated with various types of contests. In embodiments, the outcome opportunities can be associated with a game. The game can include a completive game such as American football, football (soccer), polo, water polo, baseball, basketball, cricket, rugby, cycling etc. In other embodiments, the outcome opportunities can include an outcome of a head-to-head sporting contest. The head-to-head sporting contest can include two or more contestants. In embodiments, the outcome of the sporting contest can include winner, loser, total points, partial game points, game spread, game props, and individual contest props (proposition bets). In other embodiments, the outcome opportunities can be based on an online user placing a bet on each contestant of the head-to-head sporting contest.

The system block diagram 300 can include a vigorish remover 330. The vigorish remover can remove vigorish included by the two or more digital betting platforms from the one or more betting odds opportunities. A vigorish, such as a fee, can include a percentage of a losing bet placed with a sportsbook. Vigorish can be removed for a variety of purposes. In embodiments, the removing vigorish can be used to adjust the odds discrepancy that was identified. Vigorish can differ, at times significantly, between various sportsbooks. The vigorish can obscure a betting odds discrepancy. In other embodiments, the removing the vigorish can enable identification of a potential positive expected value for the one or more betting odds opportunities. The system block diagram can enable communication between the betting odds engine 310 and a user 340. The user can include an online user. The user can access the betting odds engine via the Internet using a web browser, an app, and so on. The user can access the betting odds engine from anywhere in the world where Internet access is available. In embodiments, a request 342 can be received from the online user for the common betting odds opportunity. The request can be received through a web page, a web app, an app loaded on a personal electronic device, etc. In embodiments, an automated response 344 can be provided to the online user. The response can contain information on the common betting odds opportunity. The automated response can include an alert, an email, a text message, and the like.

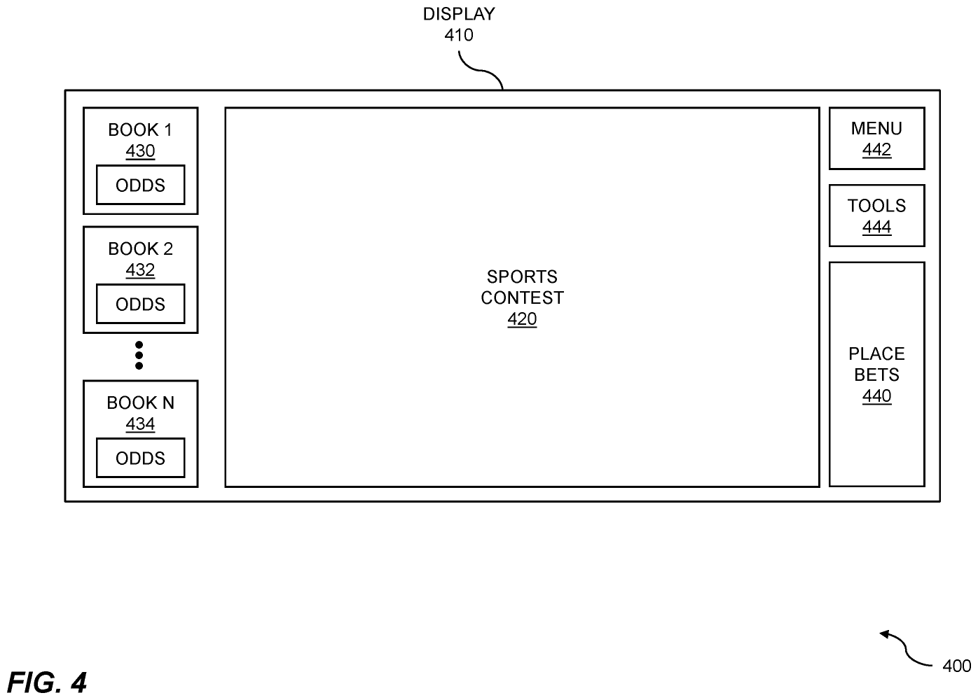

FIG. 4 illustrates a digital platform user interface. An individual can engage in activities such as online sports betting by interacting with a user interface (UI) associated with a digital platform for sports betting. The user interface can be rendered on a display of an electronic device associated with the individual. The user interface can enable the individual to interact with the sports betting platform, where the interacting can include requesting information, observing opportunities, placing one or more bets, and so on. The user interface supports a digital platform for evaluating betting odds. Two or more digital betting platforms are accessed, wherein the two or more digital betting platforms each provide one or more betting odds opportunities for an online user. The one or more betting odds opportunities are parsed from the two or more digital betting platforms to enable identification of at least one common betting odds opportunity. An odds discrepancy is identified between the two or more digital betting platforms for the common betting odds opportunity. A request is received from the online user for the common betting odds opportunity. An automated response is provided to the online user, wherein the response contains information on the common betting odds opportunity.

An example digital platform user interface is shown 400. The digital platform user interface can be rendered on a display 410. The display can include a display associated with a variety of electronic devices, personal electronic devices, portable electronic devices, and so on. The display can include a display coupled to a desktop or laptop computer, a tablet computer, a smartphone, a personal digital assistant (PDA), a smartwatch, etc. The display can further include a television screen, a projector, and so on. The user interface can present a sports contest 420. The presentation of the sports contest can include a video feed associated with the contest, the video feed with accompanying commentary, and the like. The user interface can include one or more sportsbooks, where the sportsbooks can include sportsbook 1 430, sportsbook 2 432, sportsbook N 434, and so on. The one or more sportsbooks can include odds. The odds can be associated with the sports contest, such as a head-to-head, an event within the head-to-head contest, etc. The contest can include a three or more participant contest. The odds can further be associated with sport-specific non-game events, one or more futures bets, etc. The user interface can enable placing one or more bets 440. The placing one or more bets can be accomplished by entering an amount to be wagered, choosing a sportsbook, and the like. The bets can be placed using one or more betting platforms accessed by the digital platform. The user interface can include a menu 442. The menu can be used to select an event to be rendered with the user interface, to save sports contest data, etc. The user interface can include tools 444. The tools can be used to configure the user interface, where the configuration can include a size and resolution of the interface, a number of sportsbooks to be displayed, types of events that the individual prefers, user identification and subscription information, user login credentials, and so on.

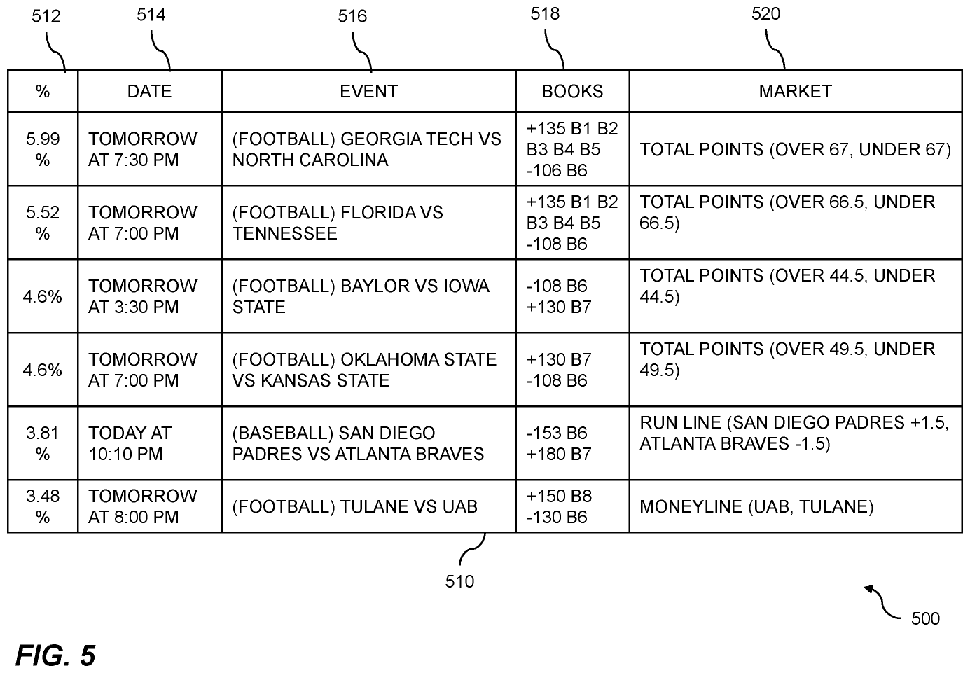

FIG. 5 is a table showing sports betting opportunities 500. Discussed above and throughout, sports betting opportunities can be provided by digital betting platforms. The digital betting platforms can be accessed via the Internet and can be positioned at various locations. The locations can include domestic locations, international locations, and so on. The sports betting opportunities can be received for examination, placing bets, and the like, by accessing the digital betting planforms. The betting opportunities can be parsed, and odds discrepancies can be identified from the parsed opportunities. The odds discrepancies can be identified using a digital platform for evaluating betting odds. Two or more digital betting platforms are accessed, wherein the two or more digital betting platforms each provide one or more betting odds opportunities for an online user. The one or more betting odds opportunities from the two or more digital betting platforms are parsed to enable identification of at least one common betting odds opportunity. An odds discrepancy is identified between the two or more digital betting platforms for the common betting odds opportunity. A request is received from the online user for the common betting odds opportunity. An automated response is provided to the online user, wherein the response contains information on the common betting odds opportunity.

A table 510 of sports betting opportunities is shown. The betting opportunities can be based on arbitrage betting. In embodiments, a bet on each contestant comprises an arbitrage bet. The table 510 can include a percentage 512 column. The percentage can indicate a percentage return resulting from placing an arbitrage bet. For an arbitrage bet, a bettor places one or more bets on all outcomes of an event. The bets are placed with different sportsbooks. The different sportsbooks can offer different odds based on differing opinions about odds, errors in setting odds, delays in discovering and amending errors in setting odds, and so on. The table can include a date column 514. A date within the date column can result from parsing data obtained by accessing two or more digital betting platforms. The parsing can analyze date information presented in differing data representation formats. The date can include the current date; a relative date such as today, tomorrow, or Saturday; etc. The date can further include an associated time. The time can include a local time for an event, a relative time such as the local time associated with a bettor, a relative time such as “two hours from now”, universal time (UTC), etc. The table can include an event column 516. The event column can include a type of sport such as American football, football (soccer), baseball, basketball, tennis, cycling, Olympic events, and the like. The event column can further include the teams, individuals, countries, and others who can be participating in the event. The table can include a books column 518. Based on the American standard for sportsbooks, a negative number can indicate a favorite in the event, while a positive number can indicate an underdog in the event. A number such as −106 can indicate an amount that can be wagered in order to win $100, while a number such as +130 can indicate an amount that can be won based on a $100 wager. The books column can also indicate one or more sportsbooks, such as B1, B2, B3, B4, B5, B6, B7, and B8. The table 500 can include a market column 520. The market can include total points, a run line, a moneyline, a spread, and so on.

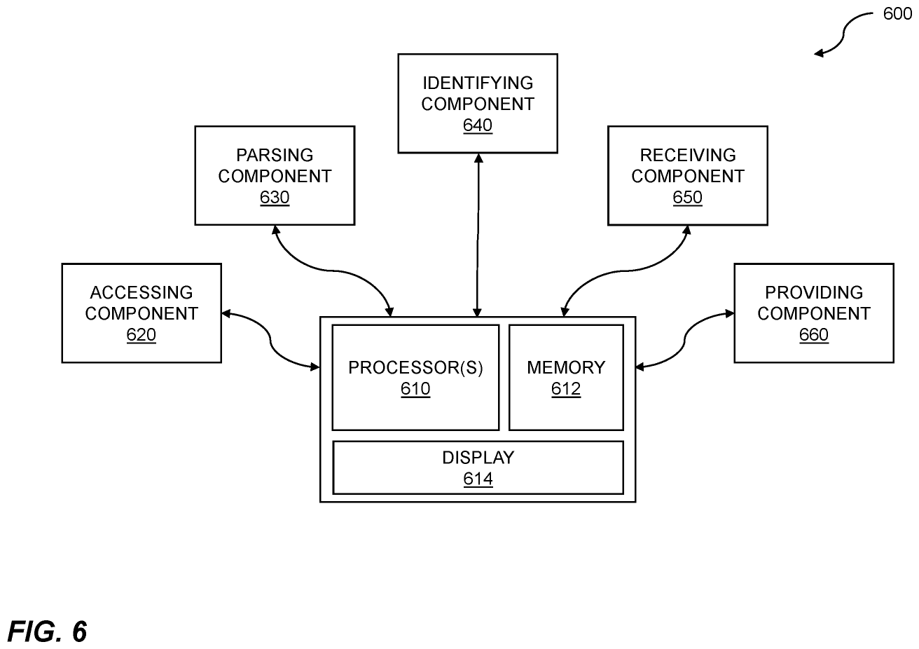

FIG. 6 is a system diagram for digitally evaluating betting odds. Techniques including parsing odds opportunities can be applied to identifying odds discrepancies between digital betting platforms. The parsing can be based on matching disparate representations of a contestant name, contest date, contest venue, or contest odds representation. The disparate representation can include nicknames, misspelled names, abbreviations, date and time formats, and so on. The parsing can also include conversion of disparate contest odds representations. An odds discrepancy is identified between the two or more digital betting platforms for the common betting odds opportunity. Periodic accessing of two or more digital betting platforms can enable dynamically identifying one or more further odds discrepancies. A request is received from the online user for the common betting odds opportunity. The request can be sent by a user through an app, a webpage, etc. An automated response is provided to the online user, wherein the response contains information on the common betting odds opportunity.

A system 600 can include one or more processors 610 connected to a memory 612 which stores instructions. The system 600 can include a display 614 coupled to the one or more processors 610 for displaying data, intermediate steps, instructions, libraries, databases, betting odds, odds discrepancies, and so on. The system 600 can include an accessing component 620, a parsing component 630, an identifying component 640, a receiving component 650, and a providing component 660. The system 600 can comprise a digital platform for evaluating betting odds. The system 600 can include an accessing component 620. The accessing component 620 can comprise accessing two or more digital betting platforms, wherein the two or more digital betting platforms each provide one or more betting odds opportunities for an online user. In embodiments, the digital betting platforms can include digital sportsbooks. The digital sportsbooks can include digital versions of sportsbooks, where a sportsbook can include a location such as an online site, application, and so on, where a bettor can gamble, place one or more wagers, play games of chance, and so on. In embodiments, the digital sportsbooks can provide at least game-level outcome odds. The digital sportsbook can provide outcome odds for head-to-head sporting contests,

The system 600 can include a parsing component 630. The parsing component 630 can parse the one or more betting odds opportunities from the two or more digital betting platforms to enable identification of at least one common betting odds opportunity. A betting odds opportunity can include identifying similar information that can be presented in different formats, orders, arrangements, and so on. In embodiments, the parsing can include matching disparate representations of a contestant name, contest date, contest venue, or contest odds representation. In a usage example, a contestant name can be presented in an order such as first name and last name, last name and first name, last name and initial, last name and a nickname, and the like. In other embodiments, the parsing can include conversion of disparate contest odds representations. The odds can be presented as numbers, percentages, differences, or deltas, etc.

The system 600 can include an identifying component 640. The identifying component 640 can identify an odds discrepancy between the two or more digital betting platforms for the common betting odds opportunity. An odds discrepancy between betting sites can be based on differences in models used to calculate odds, differences in vigorish, and so on. Odds discrepancies can be associated with an amount of time to access sportsbooks, to update odds after obtaining information associated with a contest or a participant, and the like. In embodiments, the accessing two or more digital betting platforms occurs at least twice per minute. The frequency of accessing can be varied. In embodiments, the accessing two or more digital betting platforms occurring at least twice per minute can enable dynamically identifying one or more further odds discrepancies. The dynamically identifying odds discrepancies can enable changing odds “on the fly” during a sporting event, a head-to-head contest, etc. In other embodiments, the dynamically identifying one or more further odds discrepancies enables dynamic user notification. The system 600 can include a receiving component 650. The receiving component 650 can receive a request from the online user for the common betting odds opportunity. The online user can provide the request through a website, an online form, a web app, an app loaded on a personal electronic device associated with the user, and so on. The system 600 can include a providing component 660. The providing component 660 can provide an automated response to the online user, wherein the response contains information on the common betting odds opportunity. The response can be provided through a webpage, a web app, an app in an electronic device associated with the user, etc. The response can include an alert, an email message, a text (SMS) message, and the like.

Disclosed embodiments include a computer system for evaluating betting odds comprising: a memory which stores instructions; one or more processors coupled to the memory wherein the one or more processors, when executing the instructions which are stored, are configured to: access two or more digital betting platforms, wherein the two or more digital betting platforms each provide one or more betting odds opportunities for an online user; parse the one or more betting odds opportunities from the two or more digital betting platforms to enable identification of at least one common betting odds opportunity; identify an odds discrepancy between the two or more digital betting platforms for the common betting odds opportunity; receive a request from the online user for the common betting odds opportunity; and provide an automated response to the online user, wherein the response contains information on the common betting odds opportunity.

Disclosed embodiments include a computer program product embodied in a non-transitory computer readable medium for evaluating betting odds, the computer program product comprising code which causes one or more processors to perform operations of: accessing two or more digital betting platforms, wherein the two or more digital betting platforms each provide one or more betting odds opportunities for an online user; parsing the one or more betting odds opportunities from the two or more digital betting platforms to enable identification of at least one common betting odds opportunity; identifying an odds discrepancy between the two or more digital betting platforms for the common betting odds opportunity; receiving a request from the online user for the common betting odds opportunity; and providing an automated response to the online user, wherein the response contains information on the common betting odds opportunity.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more substeps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for evaluating betting odds comprising:
accessing two or more digital betting platforms, wherein the two or more digital betting platforms each provide one or more betting odds opportunities for an online user;
parsing the one or more betting odds opportunities from the two or more digital betting platforms to enable identification of at least one common betting odds opportunity;
identifying an odds discrepancy between the two or more digital betting platforms for the common betting odds opportunity;
receiving a request from the online user for the common betting odds opportunity; and
providing an automated response to the online user, wherein the response contains information on the common betting odds opportunity.

2. The method of claim 1 wherein the digital betting platforms comprise digital sportsbooks.

3. The method of claim 2 wherein the digital sportsbooks provide at least game-level outcome odds.

4. The method of claim 1 wherein the one or more betting odds opportunities include an outcome of a head-to-head sporting contest.

5. The method of claim 4 wherein the at least one common betting odds opportunity enables the online user to place a bet on each contestant of the head-to-head sporting contest.

6. The method of claim 5 wherein the bet on each contestant guarantees a positive expected value betting outcome.

7. The method of claim 5 wherein the bet on each contestant comprises an arbitrage bet.

8. The method of claim 5 wherein the bet on each contestant comprises a low-hold bet.

9. The method of claim 5 wherein the bet on each contestant comprises a middle bet.

10. The method of claim 4 wherein the outcome of the sporting contest includes winner, loser, total points, partial game points, game spread, game props, and individual contest props.

11. The method of claim 4 wherein the common betting odds opportunity includes a statistically mispriced bet.

12. The method of claim 11 wherein the statistically mispriced bet enables a positive expected value betting outcome on one participant of the head-to-head sporting contest.

13. The method of claim 4 wherein the outcome of a head-to-head sporting contest includes sport-specific, non-game-outcome-related events.

14. The method of claim 1 wherein the at least one common betting odds opportunity enables the online user to place a bet on an outcome of a head-to-head sporting contest.

15. The method of claim 1 wherein the one or more betting odds opportunities include an outcome of a three or more participant sporting contest.

16. The method of claim 15 wherein the at least one common betting odds opportunity enables the online user to place a bet on at least one participant of the three or more participant sporting contest.

17. The method of claim 1 further comprising removing vigorish included by the two or more digital betting platforms from the one or more betting odds opportunities.

18. The method of claim 17 wherein the removing vigorish is used to adjust the odds discrepancy that was identified.

19. The method of claim 17 wherein the removing the vigorish enables identification of a potential positive expected value for the one or more betting odds opportunities.

20. The method of claim 19 wherein the potential positive expected value enables the online user to bet on a long-term basis.

21. The method of claim 1 wherein the accessing two or more digital betting platforms occurs at least twice per minute.

22. The method of claim 21 wherein the accessing two or more digital betting platforms occurs at least twice per minute and enables dynamically identifying one or more further odds discrepancies.

23. The method of claim 22 wherein the dynamically identifying one or more further odds discrepancies enables dynamic user notification.

24. The method of claim 1 wherein the parsing includes matching disparate representations of a contestant name, contest date, contest venue, or contest odds representation.

25. The method of claim 24 wherein the parsing includes conversion of disparate contest odds representations.

26. A computer program product embodied in a non-transitory computer readable medium for evaluating betting odds, the computer program product comprising code which causes one or more processors to perform operations of:
accessing two or more digital betting platforms, wherein the two or more digital betting platforms each provide one or more betting odds opportunities for an online user;
parsing the one or more betting odds opportunities from the two or more digital betting platforms to enable identification of at least one common betting odds opportunity;
identifying an odds discrepancy between the two or more digital betting platforms for the common betting odds opportunity;
receiving a request from the online user for the common betting odds opportunity; and
providing an automated response to the online user, wherein the response contains information on the common betting odds opportunity.

27. A computer system for evaluating betting odds comprising:
a memory which stores instructions;
one or more processors coupled to the memory, wherein the one or more processors, when executing the instructions which are stored, are configured to:
access two or more digital betting platforms, wherein the two or more digital betting platforms each provide one or more betting odds opportunities for an online user;
parse the one or more betting odds opportunities from the two or more digital betting platforms to enable identification of at least one common betting odds opportunity;
identify an odds discrepancy between the two or more digital betting platforms for the common betting odds opportunity;
receive a request from the online user for the common betting odds opportunity; and
provide an automated response to the online user, wherein the response contains information on the common betting odds opportunity.
